(19) United States
(12) Patent Application Publication
(10) Pub. No.: US 2015/0158536 A1
(43) Pub. Date: Jun. 11, 2015

(54) CRAWLER BELT

(71) Applicant: Hitachi Construction Machinery Co., Ltd., Tokyo (JP)

(72) Inventors: Toshikatsu Takagi, Tsuchiura-shi (JP); Yukihiko Sugiyama, Tsuchiura-shi (JP); Hiroshi Kanezawa, Kashiwa-shi (JP)

(21) Appl. No.: 14/413,450

(22) PCT Filed: Jul. 8, 2013
(86) PCT No.: PCT/JP2013/068640

§ 371 Date: Jan. 8, 2015

(30) Foreign Application Priority Data
Aug. 14, 2012 (JP) 2012-179798

(51) Int. Cl. B62D 55/20; B62D 55/21

(52) U.S. Cl. CPC B62D 55/202; B62D 55/21

(57) ABSTRACT

In each of track links (14) forming a crawler belt (13), an engaging projection (23) engaging to a drive wheel (11) is provided on a drive wheel abutting surface (22) abutting on the drive wheel (11). A fitting groove (27) composed of a bottomed recessed groove is provided on a ground contact surface (26) at the opposite side to the drive wheel abutting surface (22) in the upper-lower direction in a position corresponding to the engaging projection (23). Thereby, at the time of stacking up the track links (14) in the upper-lower direction, the fitting groove (27) of the upper track link (14) can be fitted into the engaging projection (23) of the lower track link (14).

### TECHNICAL FIELD

The present invention relates to a crawler belt used in a crawler type vehicle, such as a hydraulic excavator, a hydraulic crane, or the like.

### BACKGROUND ART

In general, a crawler type vehicle, such as a hydraulic excavator, a hydraulic crane, or the like, comprises an automotive lower traveling structure, an upper revolving structure that is revolvably mounted on the lower traveling structure, and a working mechanism that is mounted to the upper revolving structure.

Here, for example, a lower traveling structure in a large-sized crawler type vehicle is configured of a truck frame including a center frame, and side frames that are provided at both sides of the center frame in the left-right direction to extend in the front-rear direction; a drive wheel that is provided on one side of each of the side frames in the truck frame in the length direction; an idler wheel that is provided on the other side of each of the side frames in the length direction; a crawler belt that is wound around between the drive wheel and the idler wheel; and lower rollers that are provided on a lower surface of each of the side frames to guide the crawler belt between the drive wheel and the idler wheel.

The crawler belt is configured by sequentially connecting many track links with connecting pins. At the traveling of the lower traveling structure, the crawler belt is operated to circle around between the drive wheel and the idler wheel by driving and rotating the drive wheel.

Each of the track links forming part of the crawler belt in such a large-sized crawler type vehicle has the structure in which a ground contact surface in contact with the ground is formed of a flat plane or a flat plane on which an antiskid part is provided. On the other hand, a surface of the track link at the opposite side to the ground contact surface is provided with an engaging projection engaging to the drive wheel (Patent Document

### PRIOR ART DOCUMENT

### Patent Document

Patent Document 1: Japanese Patent Laid-Open No. 10-86864 A

### SUMMARY OF THE INVENTION

The ground contact surface of each of the track links by Patent Document 1 described above is formed of the flat plane or the flat plane on which the antiskid part is provided. On the other hand, the surface of the track link at the opposite to the ground contact surface is formed in an uneven shape by the engaging projection. Therefore, it is difficult to stably stack up a plurality of track links at the time of putting the track links in storage or the like as it is.

Therefore, in a case of flatwise laying the respective track links individually, there is a problem that a large space is required for keeping them in storage. On the other hand, in a case of storing each of the track links in a pallet to be stacked up for storage, the storage state becomes possibly an unstable style of packing. In addition, since it is required to prepare pallets separately, there occurs a problem of a cost increase.

In view of the above-discussed problems with the conventional art, it is an object of the present invention to provide a crawler belt that can improve efficiency of transportation and storage.

(1) The present invention is applied to a crawler belt that is configured by sequentially connecting many track links in the front-rear direction and is wound around between a drive wheel and an idler wheel on a vehicle body.

For solving the aforementioned problems, the configuration adopted by the present invention is characterized in that each of the track links comprises: a solid link base having a width dimension in the left-right direction larger than a length dimension in the front-rear direction and a height dimension in the upper-lower direction; a front connecting boss and a rear connecting boss that are respectively provided in a front end and a rear end of the link base and are connected respectively to the track links neighbored thereto; a drive wheel abutting surface that is formed in one side of the link base in the upper-lower direction and abuts on the drive wheel; and a ground contact surface that is formed in the other side of the link base in the upper-lower direction and comes in contact with the ground, wherein an engaging projection that is engaged to the drive wheel and projects from the drive wheel abutting surface is provided on the drive wheel abutting surface, and a fitting groove formed of a bottomed recessed groove into which the engaging projection can be fitted is provided in a position corresponding to the engaging projection on the ground contact surface, wherein at the time of stacking up the track links in the upper-lower direction, the fitting groove of an upper track link is fitted into the engaging projection of a lower track link.

With this arrangement, since the fitting groove is provided on the ground contact surface of the track link, at the time of stacking up the track links in the upper-lower direction, the engaging projection of the lower track link can be fitted into the fitting groove of the upper track link. Thereby, since it is possible to stably stack up many track links in the upper-lower direction in a multistep manner, the track links can be stored in a compact. As a result, it is possible to cause the wide space or the pallet for storage to be unnecessary, thus improving efficiency of transportation and storage of the track links.

(2) According to the present invention, an inner surface shape of the fitting groove is formed in a similar shape corresponding to an outer surface shape of the engaging projection. Thereby, at the time of stacking up the track links in the upper-lower direction, it is possible to securely fit the engaging projection into the fitting groove.

(3) According to the present invention, a through hole is formed inside the link base to linearly penetrate therethrough in the left-right direction. Thereby, at the manufacturing of the track link, cast sands in a core can be easily removed, and it is possible to decrease the weight of the track link.

(4) According to the present invention, the engaging projection is provided on the drive wheel abutting surface of the link base to be positioned in the central part in the left-right direction, and the fitting groove is provided on the ground contact surface of the link base to be positioned in the central part in the left-right direction. Thereby, it is possible to stably stack up the track links for storage and improve the efficiency of transportation and storage of the track links.

(5) According to the present invention, the engaging projection is provided on the drive wheel abutting surface of the link base to be positioned in the central part in the left-right direction, treads on which the drive wheel and/or the idler wheel abuts are provided at both sides of the engaging projection in the left-right direction, and left and right restricting projections are provided closer to both sides in the left-right direction than the treads to restrict a positional shift of the drive wheel, and the fitting groove is provided on the ground contact surface of the link base to be positioned in the central part in the left-right direction and left and right restricting projection fitting grooves into which the left and right restricting projections are respectively fitted are provided at both sides of the fitting groove.

With this arrangement, at the time of stacking up the track links in the upper-lower direction, the engaging projection of the lower track link can be fitted into the fitting groove of the upper track link. In addition, the left and right restricting projections of the lower track link can be fitted into the restricting projection fitting grooves of the upper track link. Thereby, at the time of stacking up many track links in the upper-lower direction, it is possible to suppress the height dimension to be low. As a result, it is possible to suppress the storage space to be narrow, and the track links can be stably stacked up for storage.

(6) According to the present invention, a tread on which the drive wheel and/or the idler wheel abuts is provided on the drive wheel abutting surface of the link base in the central part in the left-right direction and a pair of the engaging projections are provided at both sides of the tread in the left-right direction, and a pair of the fitting grooves are provided on the ground contact surface of the link base in positions corresponding to the engaging projections.

With this arrangement, at the time of stacking up the track links in the upper-lower direction, the pair of the engaging projections of the lower track link can be respectively fitted into the pair of the fitting grooves of the upper track link. Thereby, it is possible to stably stack up the track links for storage and improve the efficiency of transportation and storage of the track links.

### BRIEF DESCRIPTION OF THE DRAWINGS

FIG. 1 is a front view showing an extremely large-sized hydraulic excavator provided with a crawler belt according to a first embodiment of the present invention.

FIG. 2 is an enlarged front view showing a lower traveling structure in FIG. 1.

FIG. 3 is an enlarged cross section showing a drive wheel and a track link as viewed in a direction of arrows in FIG. 2.

FIG. 4 is an outside appearance perspective view shown by exploding a part of the track links forming the crawler belt.

FIG. 5 is a perspective view showing a single body of the track links as viewed from a ground contact surface side.

FIG. 6 is a plan view showing the single body of the track links as viewed from a drive wheel abutting surface side.

FIG. 7 is a plan view showing the single body of the track links as viewed from the ground contact surface side.

FIG. 8 is a cross section showing the track link as viewed in a direction of arrows VIII-VIII in FIG. 6.

FIG. 9 is a cross section showing the track link as viewed in a direction of arrows IX-IX in FIG. 6.

FIG. 10 is a partly broken cross section showing a state where the track links are stacked up.

FIG. 11 is a side view showing the track links as viewed from a direction of arrows XI-XI in FIG. 10.

FIG. 12 is a plan view showing a track link according to a second embodiment of the present invention in a position similar to FIG. 7.

FIG. 13 is a cross section showing the track link as viewed in a direction of arrows XIII-XIII in FIG. 12.

FIG. 14 is a partly broken cross section showing a state where the track links are stacked up in a position similar to FIG. 10.

FIG. 15 is a side view showing the track links as viewed from a direction of arrows XV-XV in FIG. 14.

FIG. 16 is an enlarged cross section showing a drive wheel and a track link according to a third embodiment of the present invention in a position similar to FIG. 3.

FIG. 17 is a perspective view showing a single body of the track links.

FIG. 18 is a partly broken cross section showing a state where the track links are stacked up in a position similar to FIG. 10.

FIG. 19 is a perspective view showing a single body of track links according to a first modification of the present invention.

FIG. 20 is a partly broken cross section showing a state where the track links are stacked up in a position similar to FIG. 10.

FIG. 21 is a perspective view showing a single body of track links according to a second modification of the present invention.

### MODE FOR CARRYING OUT THE INVENTION

Hereinafter, crawler belts according to embodiments in the present invention will be in detail explained with reference to the accompanying drawings, by taking a crawler belt in a hydraulic excavator as an example.

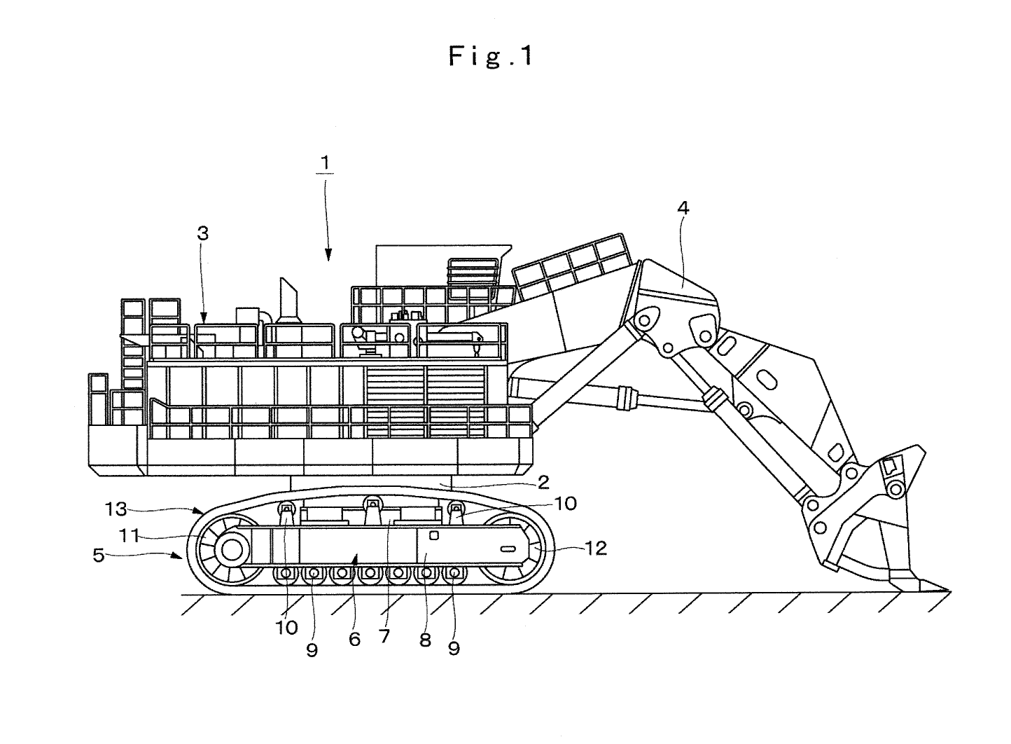

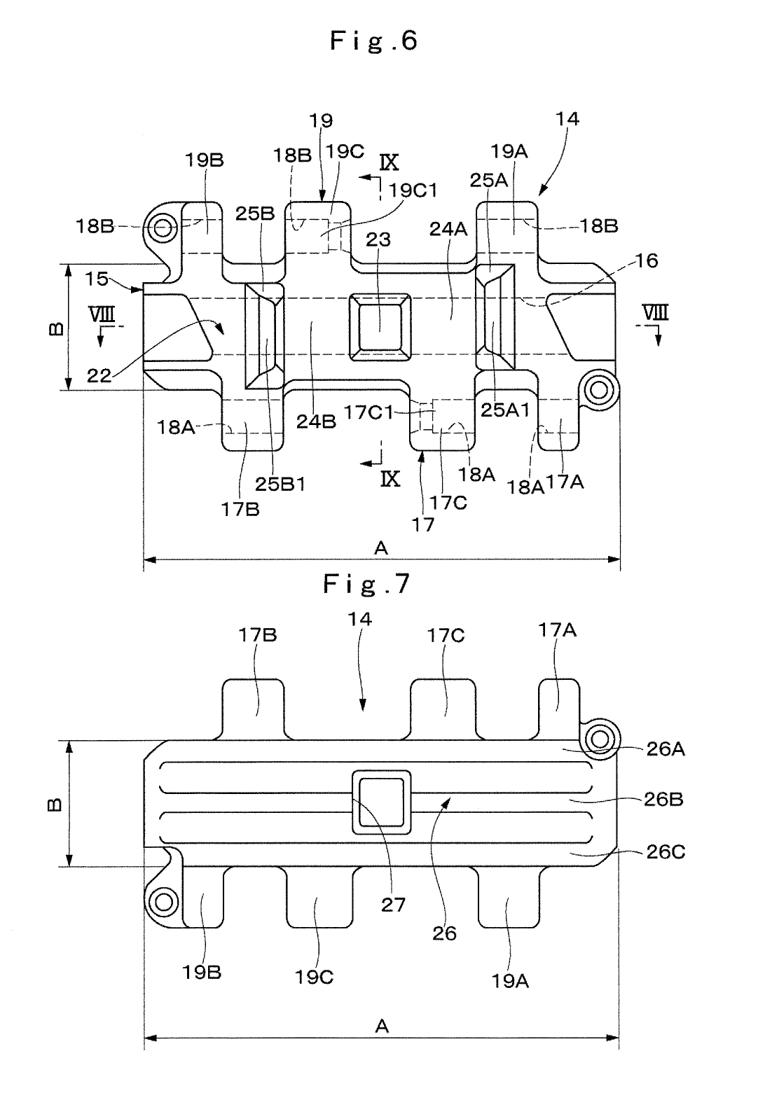

FIG. 1 to FIG. 11 show a first embodiment of the present invention.

In FIG. 1, indicated at 1 is an extremely large-sized hydraulic excavator as a construction machine. The hydraulic excavator 1 comprises a lower traveling structure 5 to be described later, an upper revolving structure 3 that forms part of a vehicle body together with the lower traveling structure 5 and is revolvably mounted on the lower traveling structure 5 through a revolving ring 2, and a working mechanism 4 that is tiltably provided in the front side of the upper revolving structure 3 for performing an excavating operation of earth and sand, or the like.

The crawler type lower traveling structure 5 is designed to stably travel on an uneven ground and a muddy ground. The lower traveling structure 5 comprises a truck frame 6, lower rollers 9, upper rollers 10, a drive wheel 11, an idler wheel 12, and a crawler belt 13, which will be described later.

The truck frame 6 comprises a center frame 7 that is positioned in the central part in the left-right direction, and side frames 8 that are provided at both sides of the center frame 7 in the left-right direction and extend in a front-rear direction.

The revolving ring 2 forming part of a revolving device is mounted on the center of the center frame 7, and the upper revolving structure 3 is mounted thereon through the revolving ring 2.

The left and right side frames 8 (only the right side frame 8 is shown) form part of the truck frame 6 together with the center frame 7. The side frame 8 is arranged to extend in the front-rear direction of the hydraulic excavator 1 and is mounted on a tip end of each of leg parts 7A of the center frame 7. The side frame 8 is formed as an angular cylindrical canning structure extending in the front-rear side, for example, by welding a steel plate.

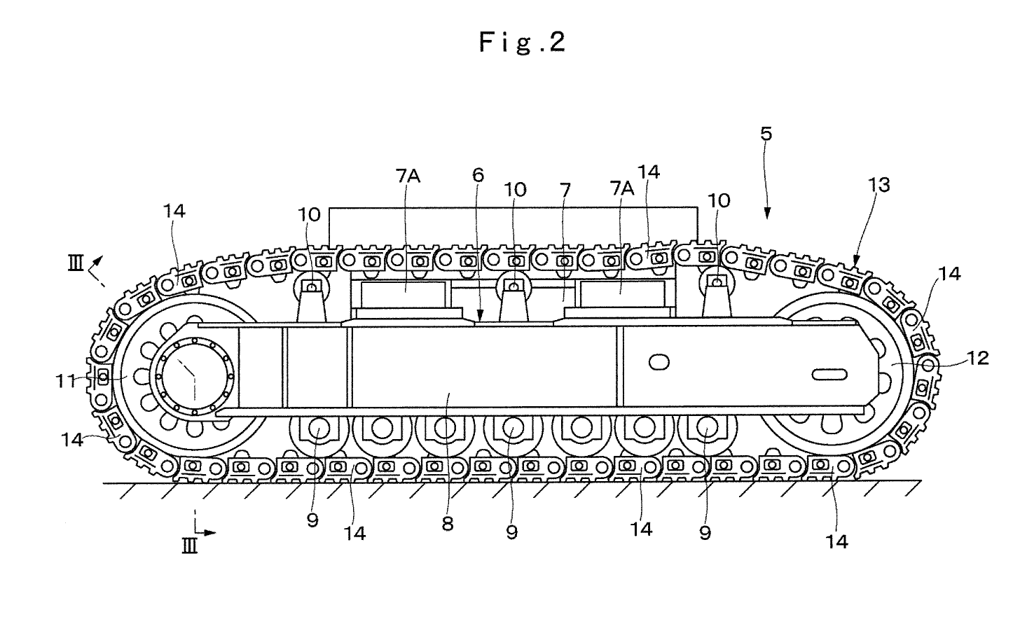

The lower roller 9 comprises a plurality of lower rollers that are provided on a lower surface side of the side frame 8. As shown in FIG. 2, the lower rollers 9 respectively are disposed at a predetermined interval in the front-rear direction from each other. The lower rollers 9 are respectively positioned between the drive wheel 11 and the idler wheel 12 to be described later and roll on drive wheel abutting surfaces 22 of the crawler belt 13 (track links 14) to be described later to guide the crawler belt 13 in a circling direction in such a manner as to press the crawler belt 13 from above to ground.

The upper roller 10 comprises a plurality of upper rollers that are provided on an upper surface side of the side frame 8. As shown in FIG. 2, the upper rollers 10 respectively are disposed at a predetermined interval in the front-rear direction from each other. The upper rollers 10 respectively guide the crawler belt 13 in a circling direction by supporting the crawler belt 13 (track links 14) from under between the drive wheel 11 and the idler wheel 12 to be described later.

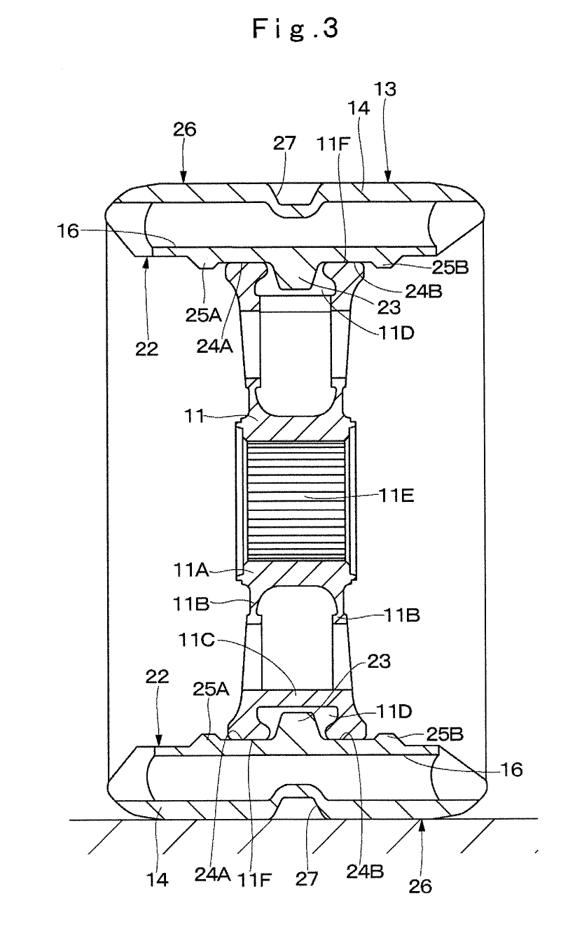

The drive wheel 11 is provided in one side of the side frame 8 in the length direction. The drive wheel 11 is mounted on the side frame 8 through a hydraulic motor (not shown), and drives the crawler belt 13 to go around by the hydraulic motor. Here, as shown in FIG. 3, the drive wheel 11 is formed of a short cylindrical part 11A, two disks 11B that are provided at a predetermined interval in an axial direction on an outer peripheral side of the cylindrical part 11A, and a plurality of connecting parts 11C (only one thereof is shown in FIG. 3) that are arranged at a predetermined interval in a circumferential direction on the outer peripheral side of each of the disks 11B and connect the respective disks 11B in a ladder shape over an entire circumference. A recessed part 11D is provided between the neighbored connecting parts 11C. An inner peripheral side of the cylindrical part 11A forms a spline hole 11E to which an output shaft (not shown) of the hydraulic motor is jointed.

Here, each of the recessed parts 11D of the drive wheel 11 is engaged (meshed) to an engaging projection 23 of each of the track links 14 to be described later. An outer peripheral surface of each of the disks 11B forming the drive wheel 11 forms part of an abutting surface 11F. The abutting surface 11F abuts on a left tread 24A and a right tread 24B to be described later that are provided in each of the track links 14.

On the other hand, the idler wheel 12 is provided in the other side of each of the side frames 8 in the length direction. The idler wheel 12 adjusts tension of the crawler belt 13 to be described later by a crawler belt tension adjusting mechanism (not shown), and is urged toward the other side of the side frame 8 in the length direction.

Next, the crawler belt 13 applied to the first embodiment will be explained.

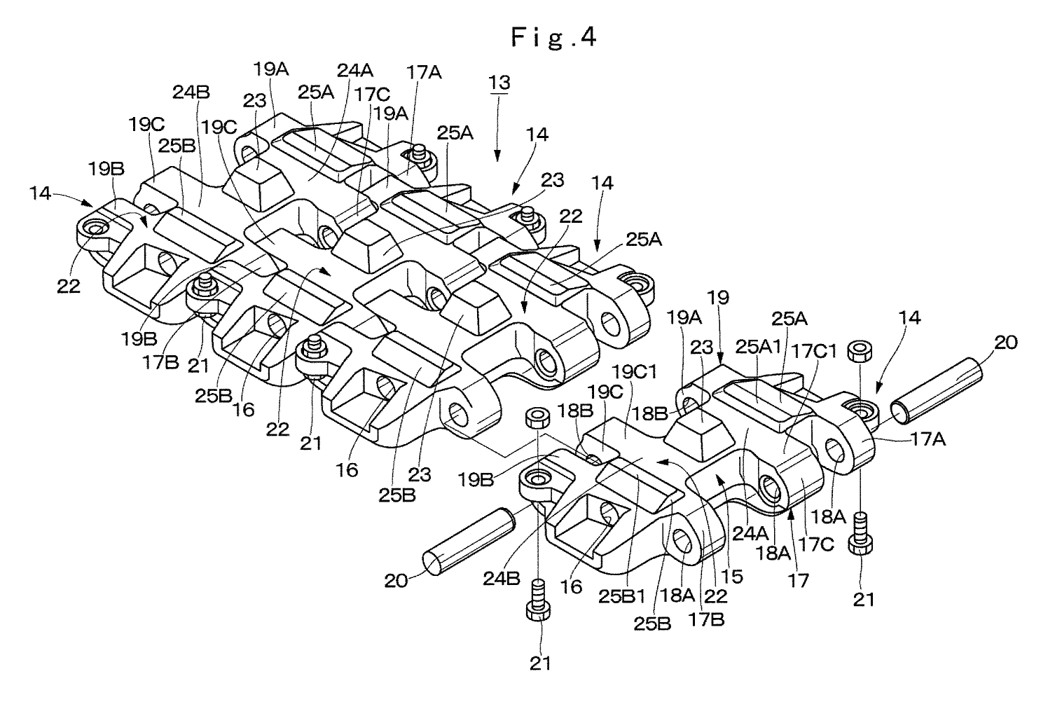

That is, designated at 13 is the crawler belt that is provided to be wound around the drive wheel 11 and the idler wheel 12. As shown in FIG. 2 and FIG. 4, the crawler belt 13 is formed as an endless track by sequentially connecting a great number of the track links 14 in the front-rear direction.

Designated at 14 are the track links 14 forming the crawler belt 13. The track links 14 each are formed as a hollow box structure the inside of which is hollow, and are integrally formed, for example, by casting means. The track link 14 comprises a link base 15, a front connecting boss 17, a rear connecting boss 19, the drive wheel abutting surface 22, and a ground contact surface 26, which will be described later.

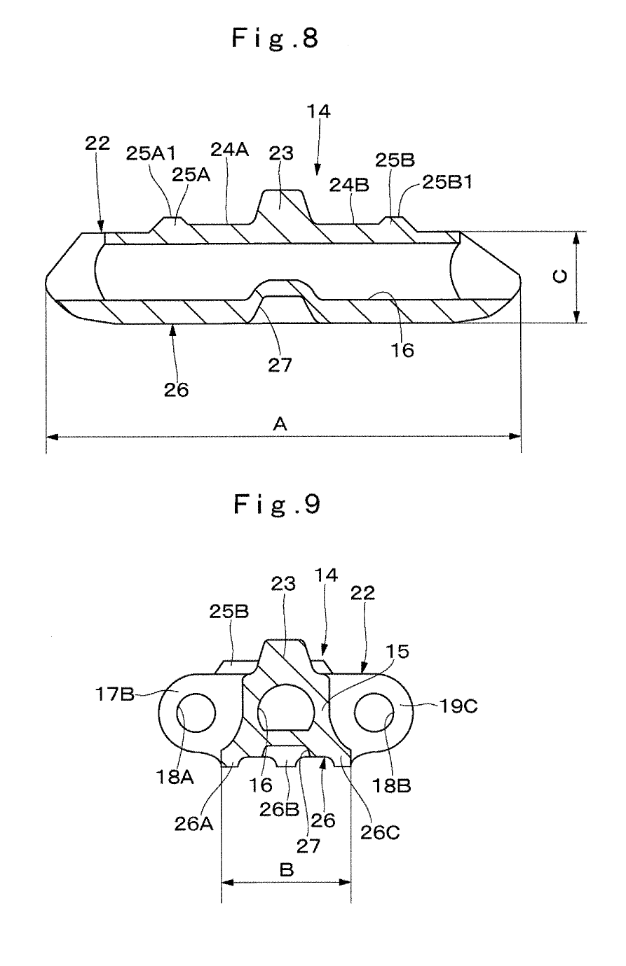

The link base 15 forms a main body of the track link 14, and has a solid shape in which a width dimension A in the left-right direction is larger than a length dimension B in the front-rear direction and a height dimension C in the upper-lower direction. As shown in FIG. 4, FIG. 8 and FIG. 9, a through hole 16 having a circular section is provided in the link base 15 to linearly penetrate therethrough in the left-right direction. A core is to filled in the through hole 16 at the time of manufacturing the track link 14. In this case, the through hole 16 linearly penetrates in the left-right direction, which causes casting sands of a core to be easily removed therefrom, and a weight of the track link 14 to be reduced. As a result, the link base 15 is formed as a hollow box structure an inside of which has a substantially cylindrical shape in section.

The front connecting boss 17 is provided in a front end of the link base 15, and, at the time of connecting the respective track links 14, is connected to a front side track link 14 neighbored thereto. As shown in FIG. 4, the front connecting boss 17 includes a left front connecting boss 17A that projects from the front end of the link base 15 in the left side thereof, a right front connecting boss 17B that projects from the front end of the link base 15 in the right side thereof, and a center front connecting boss 17C that is positioned between the left front connecting boss 17A and the right front connecting boss 17B and projects from the front end of the link base 15 in the left side a little away from the center of the link base 15. An upper surface 17C1 of the center front connecting boss 17C is continuous to a left tread 24A to be described later. A pin through hole 18A is formed in each of the front connecting bosses 17A, 17B, 17C concentrically to penetrate therethrough in the left-right direction.

On the other hand, the rear connecting boss 19 is provided in a rear end of the link base 15, and, at the time of connecting the respective track links 14, is connected to a rear side track link 14 neighbored thereto. As shown in FIG. 4, the rear connecting boss 19 includes a left rear connecting boss 19A that projects from the rear end of the link base 15 in the left side thereof, a right rear connecting boss 19B that projects from the rear end of the link base 15 in the right side thereof, and a center rear connecting boss 19C that is positioned between the left rear connecting boss 19A and the right rear connecting boss 19B and projects from the rear end of the link base 15 in the right side a little away from the center of the link base 15. An upper surface 19C1 of the center rear connecting boss 19C is continuous to a right tread 24B to be described later. A pin through hole 18B is formed in each of the rear connecting bosses 19A, 19B, 19C concentrically to penetrate therethrough in the left-right direction.

As shown in FIG. 4, in each of the track links 14, the left rear connecting boss 19A in the front side track link 14 is inserted between the left front connecting boss 17A and the center front connecting boss 17C in the rear side track link 14. The right front connecting boss 17B in the rear side track link 14 is inserted between the right rear connecting boss 19B and the center rear connecting boss 19C in the front side track link 14. In this state, a connecting pin 20 is inserted into each of the pin holes 18A, 18B and a retaining bolt 21 is attached thereto. Thereby, the respective track links 14 are connected in an endless manner (in a circular manner) to form the crawler belt 13.

Designated at 22 is the drive wheel abutting surface that is formed in one side of the link base 15 in the upper-lower direction. The drive wheel abutting surface 22 is formed as part of an inner peripheral side of each of the respective track links 14 at the time of connecting a great number of the track links 14 in an endless manner to be a surface abutting on the drive wheel 11. The drive wheel abutting surface 22 is provided with an engaging projection 23, the left tread 24A, the right tread 24B, a left restricting projection 25A and a right restricting projection 25B, which will be described later.

Designated at 23 is the engaging projection that is provided on the drive wheel abutting surface 22. The engaging projection 23 is positioned in the central part of the drive wheel abutting surface 22 in the left-right direction as a rectangular projecting body, and is provided to project from the drive wheel abutting surface 22. As shown in FIG. 3, the engaging projection 23 of the track link 14 is engaged (meshed) to the recessed part 11D of the drive wheel 11. Therefore, the drive wheel 11 can securely transmit a rotational force to the crawler belt 13 without generation of the sliding.

The left tread 24A is provided on the drive wheel abutting surface 22 to be positioned in the left side of the engaging projection 23. The left tread 24A is formed as a flat plane continuous to the upper surface 17C1 of the center front connecting boss 17C, and the drive wheel 11 and/or the idler wheel 12 abuts thereon. Specifically, the left tread 24A abuts on the abutting surface 11F of the drive wheel 11 at the time the track link 14 is engaging to the drive wheel 11. On the other hand, the left tread 24A abuts on the outer peripheral side of the idler wheel 12 at the time the track link 14 is engaging to the idler wheel 12. Further, the lower roller 9 and the upper roller 10 also abut on the left tread 24A.

On the other hand, the right tread 24B is provided on the drive wheel abutting surface 22 to be positioned in the right side of the engaging projection 23. The right tread 24B is formed as a flat plane continuous to the upper surface 19C1 of the center rear connecting boss 19C, and the drive wheel 11 and/or the idler wheel 12 abuts thereon. Specifically, the right tread 24B abuts on the abutting surface 11F of the drive wheel 11 at the time the track link 14 is engaging to the drive wheel 11. On the other hand, the right tread 24B abuts on the outer peripheral side of the idler wheel 12 at the time the track link 14 is engaging to the idler wheel 12. Further, the lower roller 9 and the upper roller 10 also abut on the right tread 24B.

The left restricting projection 25A is provided on the drive wheel abutting surface 22 to be positioned closer to the left side in the left-right direction than the left tread 24A. The left restricting projection 25A is formed of a rectangular projecting body an upper surface 25A1 of which is flat in a horizontal direction. The left restricting projection 25A is provided to project upward from the drive wheel abutting surface 22, and extend in the left side of the left tread 24A in the front-rear direction. Accordingly, when the drive wheel 11 is to be shifted in the left direction on the left tread 24A, an outer peripheral edge of the disk 11B of the drive wheel 11 comes in contact with the left restricting projection 25A, thus making it possible to restrict the positional shift of the drive wheel 11.

On the other hand, the right restricting projection 25B is provided on the drive wheel abutting surface 22 to be positioned closer to the right side in the left-right direction than the right tread 24B. The right restricting projection 25B is, as similar to the left restricting projection 25A, formed of a rectangular projecting body an upper surface 25B1 of which is flat in a horizontal direction. The right restricting projection 25B is provided to project upward from the drive wheel abutting surface 22, and extend in the right side of the right tread 24B in the front-rear direction. Accordingly, when the drive wheel 11 is to be shifted in the right direction on the right tread 24B, an outer peripheral edge of the disk 11B of the drive wheel 11 comes in contact with the right restricting projection 25B, thus making it possible to restrict the positional shift of the drive wheel 11.

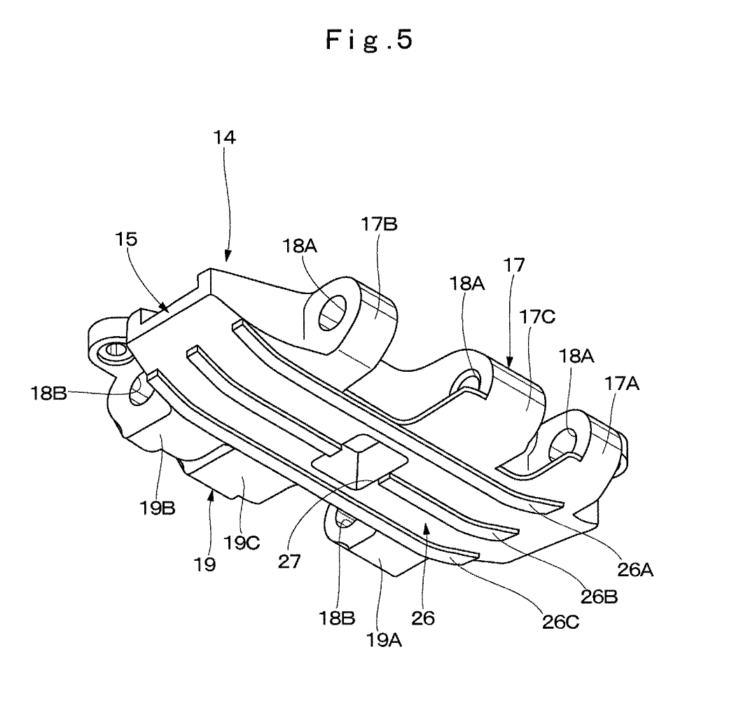

Designated at 26 is the ground contact surface that is formed in the other side of the link base 15 in the upper-lower direction. The ground contact surface 26 is positioned at the opposite side to the drive wheel abutting surface 22 in the upper-lower direction, and is formed as part of an outer peripheral side of each of the track links 14 to be a surface in contact with the ground at the time of connecting a great number of the track links 14 in an endless manner (in a circular manner). As shown in FIG. 5 and FIG. 7, the ground contact surface 26 is provided with three antiskid parts 26A, 26B, 26C that extend in the left-right direction and are arranged in parallel in the front-rear direction, and a fitting groove 27 to be described later is provided in the central part of the ground contact surface 26.

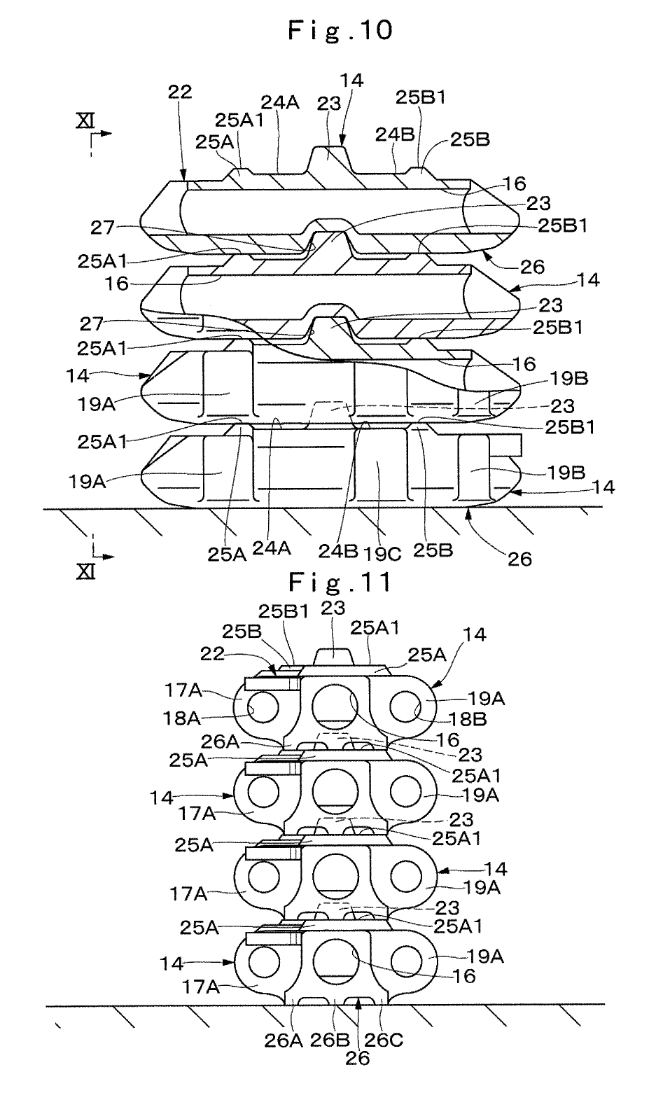

Designated at 27 is the fitting groove that is provided to be positioned in the central part of the ground contact surface 26 in the left-right direction. The fitting groove 27 is formed as a bottomed recessed groove in a position corresponding to the engaging projection 23 to be recessed from the ground contact surface 26 toward the drive wheel abutting surface 22. Here, an inner surface shape of the fitting groove 27 is formed in a similar shape corresponding to an outer surface shape of the engaging projection 23, more specifically, is formed in a similar shape slightly larger than the outer surface shape of the engaging projection 23. Thereby, as shown in FIG. 10 and FIG. 11, at the time of stacking up the track links 14 in the upper-lower direction, the fitting groove 27 of the upper track link 14 can be fitted into the engaging projection 23 of the lower track link 14.

The hydraulic excavator 1 according to the first embodiment has the above-mentioned configuration, and next, an explanation will be made of a work for storing the track links 14 forming the crawler belt 13 of the hydraulic excavator 1 in a warehouse or the like.

The track link 14 of the extremely large-sized hydraulic excavator 1 has a width dimension A of approximately 1200 mm in the left-right direction and a length dimension B of approximately 600 to 700 mm in the front-rear direction, and a weight of several hundred kg. For this reason, a forklift, a crane or the like is used to transport or move each of the track links 14.

Here, at the time of stacking up track links in the conventional technology in the upper-lower direction for storage in a warehouse or the like, since the engaging projection projecting from the drive wheel abutting surface of the lower track link abuts on the ground contact surface of the upper track link, it is difficult to stably stack up the track links in the upper-lower direction as it is. Therefore, in a case of flatwise laying the respective track links individually, unfortunately a large space is required for keeping them in storage.

On the other hand, in the track link 14 according to the first embodiment, the ground contact surface 26 is provided with the fitting groove 27 into which the engaging projection 23 can be fitted, and therefore it is possible to stack up the track links 14 in a stable condition in a multistep manner in a warehouse or the like.

Specifically, as shown in FIG. 10 and FIG. 11, the track link 14 is lifted up by a fork lift, a crane or the like (not shown), and the fitting groove 27 of the lifted track link 14 is fitted into the engaging projection 23 of the lower track link 14, thus making it possible to stack up the track links 14. At the time of thus stacking up the track links 14, the ground contact surface 26 of the upper track link 14 is placed on the upper surface 25A1 of the left restricting projection 25A and on the upper surface 25B1 of the right restricting projection 25B provided in the drive wheel abutting surface 22 of the lower track link 14. At this time, since each of the upper surface 25A1 of the left restricting projection 25A and the upper surface 25B1 of the right restricting projection 25B is formed as a flat plane, the lower track link 14 can stably support the upper track link 14.

Thus, according to the first embodiment, since the track links 14 can be stably stacked up in the upper-lower direction in a multistep manner, the track links 14 can be stored in a compact state. As a result, it is possible to cause a wide space or a pallet for storage to be unnecessary to improve efficiency of transportation and storage of the track links 14.

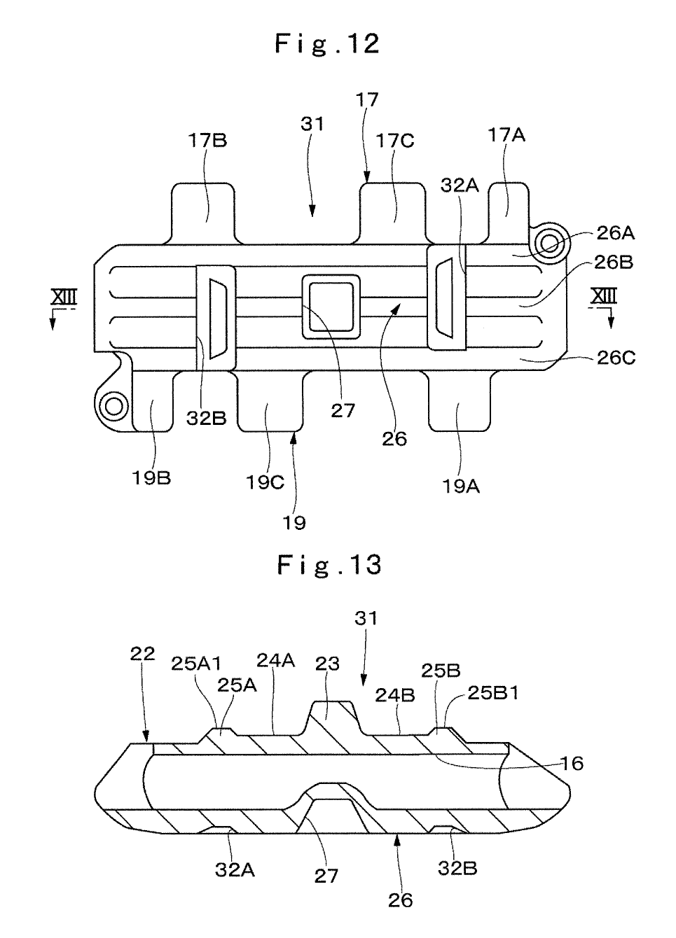

Next, FIG. 12 to FIG. 15 show a second embodiment. The second embodiment is characterized in that a ground contact surface of a track link is provided with a fitting groove, and further, left and right restricting projection fitting grooves. It should be noted that in the second embodiment, component elements that are identical to those in the foregoing first embodiment will be simply denoted by the same reference numerals to avoid repetitions of similar explanations.

Designated at 31 are track links forming the crawler belt 13, and the track links 31 each is formed as a hollow box structure the inside of which is hollow, and, are integrally formed, for example, by casting means. The track link 31 comprises the link base 15, the front connecting boss 17, the rear connecting boss 19, the drive wheel abutting surface 22, and the ground contact surface 26, but the track link 31 according to the second embodiment differs in a point where a left restricting projection fitting groove 32A and a right restricting projection fitting groove 32B, which will be described later, are provided on the ground contact surface 26, from the track link 14 according to the first embodiment.

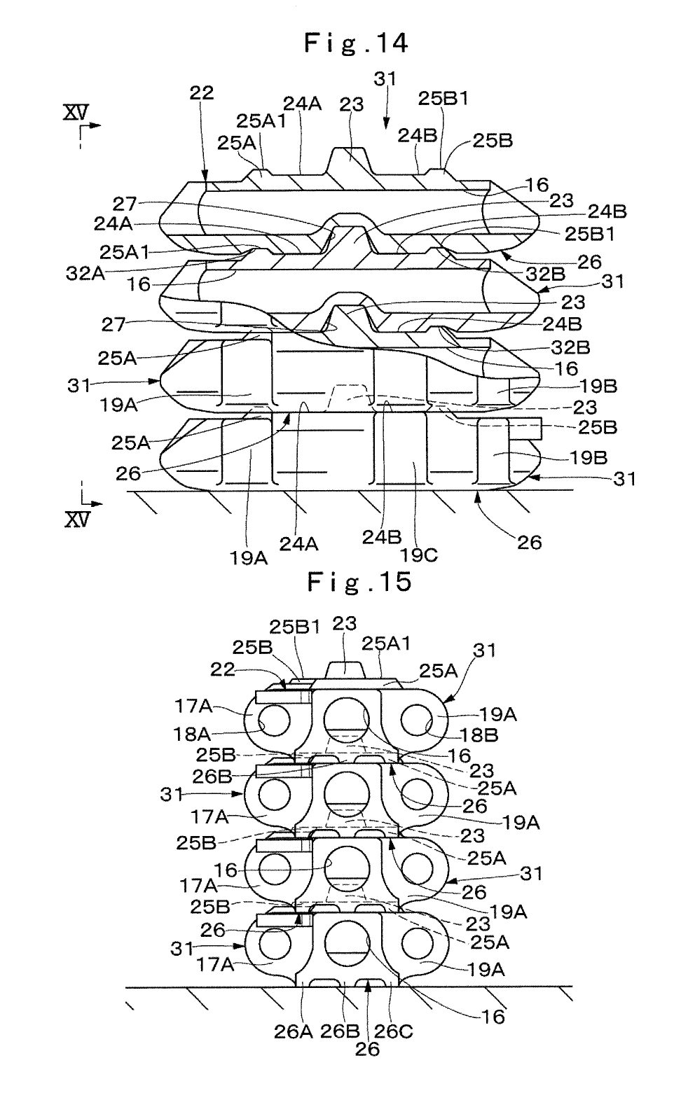

The left restricting projection fitting groove 32A is provided on the ground contact surface 26 to be positioned in the left side of the fitting groove 27. The left restricting projection fitting groove 32A is formed as a bottomed recessed groove in a position corresponding to the left restricting projection 25A to be recessed from the ground contact surface 26 toward the drive wheel abutting surface 22. An inner surface shape of the left restricting projection fitting groove 32A is formed in a similar shape corresponding to an outer surface shape of the left restricting projection 25A, more specifically, is formed in a similar shape slightly larger than the outer surface shape of the left restricting projection 25A. Thereby, as shown in FIG. 14 and FIG. 15, at the time of stacking up the track links 31 in the upper-lower direction, the left restricting projection 25A of the lower track link 31 can be fitted into the left restricting projection fitting groove 32A of the upper track link 31.

On the other hand, the right restricting projection fitting groove 32B is provided on the ground contact surface 26 to be positioned in the right side of the fitting groove 27. The right restricting projection fitting groove 32B is formed as a bottomed recessed groove in a position corresponding to the right restricting projection 25B to be recessed from the ground contact surface 26 toward the drive wheel abutting surface 22. An inner surface shape of the right restricting projection fitting groove 32B is formed in a similar shape corresponding to an outer surface shape of the right restricting projection 25B, more specifically, is formed in a similar shape slightly larger than the outer surface shape of the right restricting projection 25B. Thereby, as shown in FIG. 14 and FIG. 15, at the time of stacking up the track links 31 in the upper-lower direction, the right restricting projection 253 of the lower track link 31 can be fitted into the right restricting projection fitting groove 32B of the upper track link 31.

At this time, the ground contact surface 26 of the upper track link 31 is placed on the left tread 24A and the right tread 24B of the lower track link 31. Since each of the treads 24A, 243 is formed as a flat plane, the lower track link 31 can stably support the upper track link 31.

Thus, according to the second embodiment, at the time of stacking up the track links 31 in the upper-lower direction, the left restricting projection 25A and the right restricting projection 25B provided to project in the drive wheel abutting surface 22 side of the track link 31 are fitted into the left restricting projection fitting groove 32A and the right restricting projection fitting groove 32B provided on the ground contact surface 26. Therefore, at the time of stacking up many track links 31 in the upper-lower direction, it is possible to suppress the height dimension to be low. As a result, it is possible to suppress the storage space to be narrow, and stably stack up the track links 31 for storage.

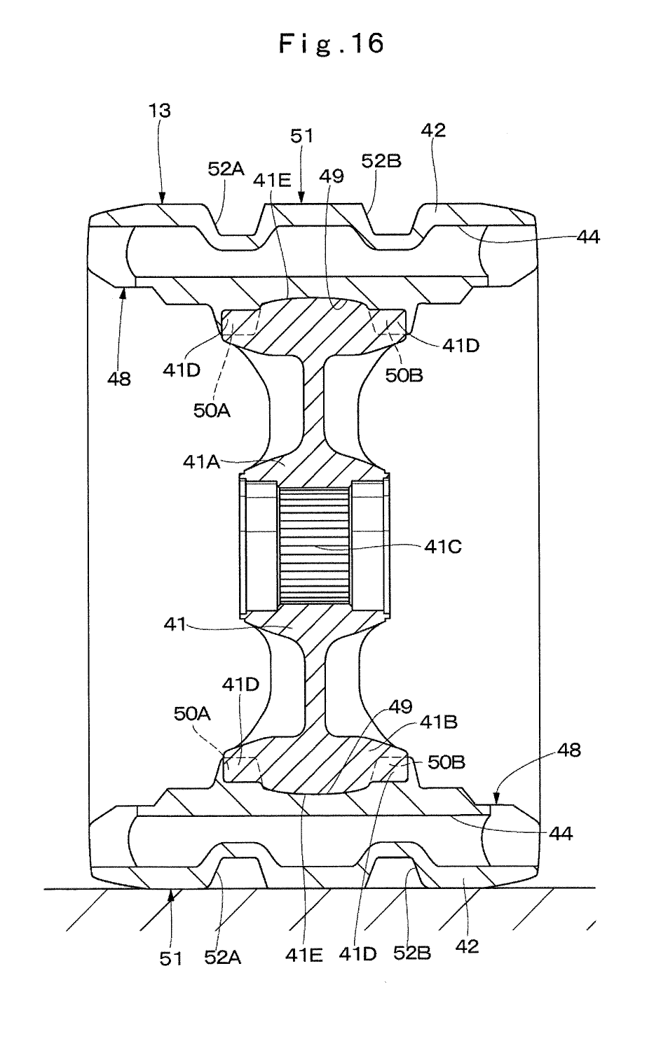

Next, FIG. 16 to FIG. 18 show a third embodiment. The third embodiment is characterized in that a tread is provided in the central part of a drive wheel abutting surface in a track link in the left-right direction, a pair of engaging projections are provided at both sides of the tread in the left-right direction.

Further, a ground contact surface of the track link is provided with a pair of fitting grooves corresponding to the engaging projections respectively. It should be noted that in the third embodiment, component elements that are identical to those in the foregoing first embodiment will be simply denoted by the same reference numerals to avoid repetitions of similar explanations.

Designated at 41 is a drive wheel according to the third embodiment, which is provided in one side of each of the side frames 8 in the length direction. The drive wheel 41 is attached to the side frame 8 through a hydraulic motor (not shown), and drives a crawler belt 13 to go around. Here, as shown in FIG. 16, the drive wheel 41 includes a short inner cylinder 41A and an outer cylinder 41B, and an inner peripheral side of the inner cylinder 41A forms part of a spline hole 41C to which an output shaft (not shown) of the hydraulic motor is jointed.

Many meshing parts 41D projecting axially from the outer cylinder 41B are provided to line up in both end edges of the outer cylinder 41B at equal intervals in the circumferential direction. A left engaging projection 50A and a right engaging projection 503 in each of the track links 42 to be described later are engaged (meshed) between the neighbored meshing parts 41D.

Further, an outer peripheral surface of the outer cylinder 41B becomes an abutting surface 41E, and a tread 49, which will be described later, provided in each of the track links 42 abuts on the abutting surface 41E.

Designated at 42 are the track links according to the third embodiment, which form the crawler belt 13. The track links 42 each are formed as a hollow box structure the inside of which is hollow, and, are integrally formed, for example, by casting means. The track link 42 comprises a link base 43, a front connecting boss 45, a rear connecting boss 47, a drive wheel abutting surface 48, and a ground contact surface 51.

The link base 43 forms a main body of the track link 42, and has a solid shape in which a width dimension in the left-right direction is larger than a length dimension in the front-rear direction and a height dimension in the upper-lower direction. As shown in FIG. 16 to FIG. 18, a through hole 44 having a circular section is provided in the link base 43 to linearly penetrate therethrough in the left-right direction. A core is filled in the through hole 44 at the time of manufacturing the track link 42. In this case, the through hole 44 linearly penetrates in the left-right direction, which causes casting sands in the core to be easily removed therefrom, and a weight of the track link 42 to be reduced. As a result, the link base 43 is formed as a hollow box structure an inside of which has a substantially cylindrical shape in section.

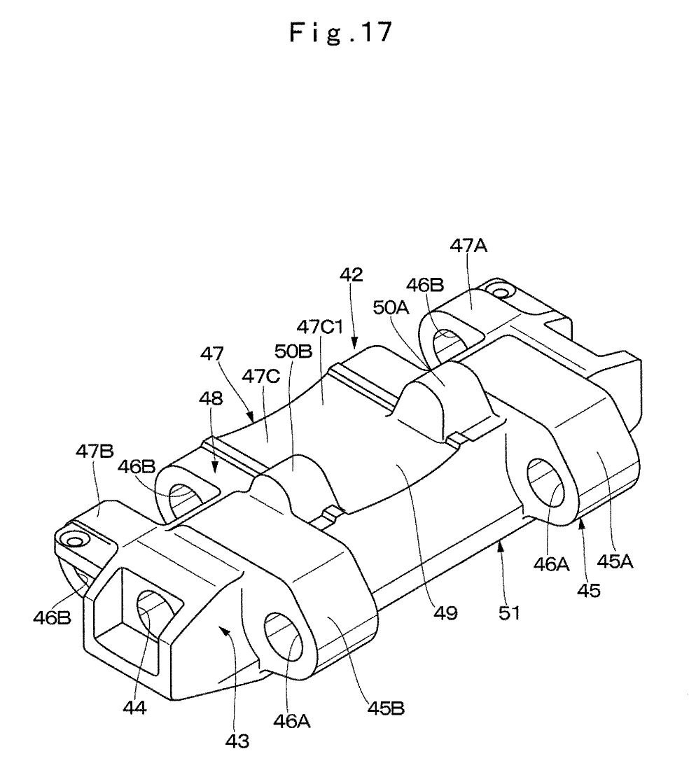

The front connecting boss 45 is provided in a front end of the link base 43, and, at the time of connecting the respective track links 42, is connected to the neighbor front side track link 42. As shown in FIG. 17, the front connecting boss 45 includes a left front connecting boss 45A that projects from the front end of the link base 43 in the left side thereof, a right front connecting boss 45B that projects from the front end of the link base 43 in the right side thereof. A pin through hole 46A is formed in each of the front connecting bosses 45A, 45B concentrically to penetrate therethrough in the left-right direction.

On the other hand, the rear connecting boss 47 is provided in a rear end of the link base 43, and, at the time of connecting the respective track links 42, is connected to the neighbor rear side track link 42. As shown in FIG. 17, the rear connecting boss 47 includes a left rear connecting boss 47A that projects from the rear end of the link base 43 in the left side thereof, a right rear connecting boss 47B that projects from the rear end of the link base 43 in the right side thereof, and a center rear connecting boss 47C that is positioned between the left rear connecting boss 47A and the right rear connecting boss 47B and projects from the rear end of the link base 43 in the center of the link base 43. An upper surface 47C1 of the center rear connecting boss 47C is continuous to the tread 49 to be described later. A pin through hole 46B is formed in each of the rear connecting bosses 47A, 47B, 47C concentrically to penetrate therethrough in the left-right direction.

In each of the track links 42, the left front connecting boss 45A in the rear side track link 42 is inserted between the left rear connecting boss 47A and the center rear connecting boss 47C in the front side track link 42. The right front connecting boss 45B in the rear side track link 42 is inserted between the right rear connecting boss 47B and the center rear connecting boss 47C in the front side track link 42. In this state, a connecting pin (not shown) is inserted into each of the pin holes 46A, 46B and a retaining bolt (not shown) is attached thereto. Thereby, the respective track links 42 are connected in an endless manner to form the crawler belt 13.

Designated at 48 is the drive wheel abutting surface that is formed in one side of the link base 43 in the upper-lower direction. The drive wheel abutting surface 48 is formed as part of an inner peripheral side of each of the circularly connected track links 42 to be a surface abutting on the drive wheel 41.

The drive wheel abutting surface 48 is provided with the tread 49, the left engaging projection 50A and the right engaging projection 50B, which will be described later. Both end sides of the drive wheel abutting surface 48 in the left-right direction (closer to an outer side in the width direction than the left engaging projection 50A and the right engaging projection 50B) are formed as flat planes continuous to the front connecting bosses 45A, 45B.

The tread 49 is provided in the central part of the drive wheel abutting surface 48 in the left-right direction. The tread 49 is continuous to the upper surface 47C1 of the center rear connecting boss 47C, and the drive wheel 41 and/or the idler wheel 12 abuts thereon. Specifically, the tread 49 abuts on the abutting surface 41E of the drive wheel 41 at the time the track link 42 is engaging to the drive wheel 41. On the other hand, the tread 49 abuts on the outer peripheral side of the idler wheel 12 at the time the track link 42 is engaging to the idler wheel 12. Further, the lower roller 9 and the upper roller 10 also abut on the tread 49.

Designated at 50A and 50B are a pair of the engaging projections that project from the drive wheel abutting surface 48. The left engaging projection 50A is provided to project in the left side of the tread 49 as a rectangular projecting body. On the other hand, the right engaging projection 50B is provided to project in the right side of the tread 49 as a rectangular projecting body. As shown in FIG. 16, each of the engaging projections 50A, 50B of the track link 42 is engaged between the respective meshing parts 41D of the drive wheel 41. Therefore, the drive wheel 41 can securely transmit a rotational force to the crawler belt 13 without generation of the sliding.

Designated at 51 is the ground contact surface that is formed in the other side of the link base 43 in the upper-lower direction. The ground contact surface 51 is positioned at the opposite side to the drive wheel abutting surface 48 in the upper-lower direction, and is formed as part of an outer peripheral side of each of the track links 42 to be a surface in contact with the ground at the time of connecting a great number of the track links 42 in a circular manner.

Designated at 52A, 52B are a pair of the fitting grooves that are provided in the ground contact surface 51 to be positioned in the left-right direction. The left fitting groove 52A is formed as a bottomed recessed groove in a position corresponding to the left engaging projection 50A to be recessed from the ground contact surface 51 toward the drive wheel abutting surface 48. Here, an inner surface shape of the left fitting groove 52A is formed in a similar shape corresponding to an outer surface shape of the left engaging projection 50A, more specifically, is formed in a similar shape slightly larger than the outer surface shape of the left engaging projection 50A.

On the other hand, the right fitting groove 52B is formed as a bottomed recessed groove in a position corresponding to the right engaging projection 50B to be recessed from the ground contact surface 51 toward the drive wheel abutting surface 48. Here, an inner surface shape of the right fitting groove 52B is formed in a similar shape corresponding to an outer surface shape of the right engaging projection 50B, more specifically, is formed in a similar shape slightly larger than the outer surface shape of the right engaging projection 50B.

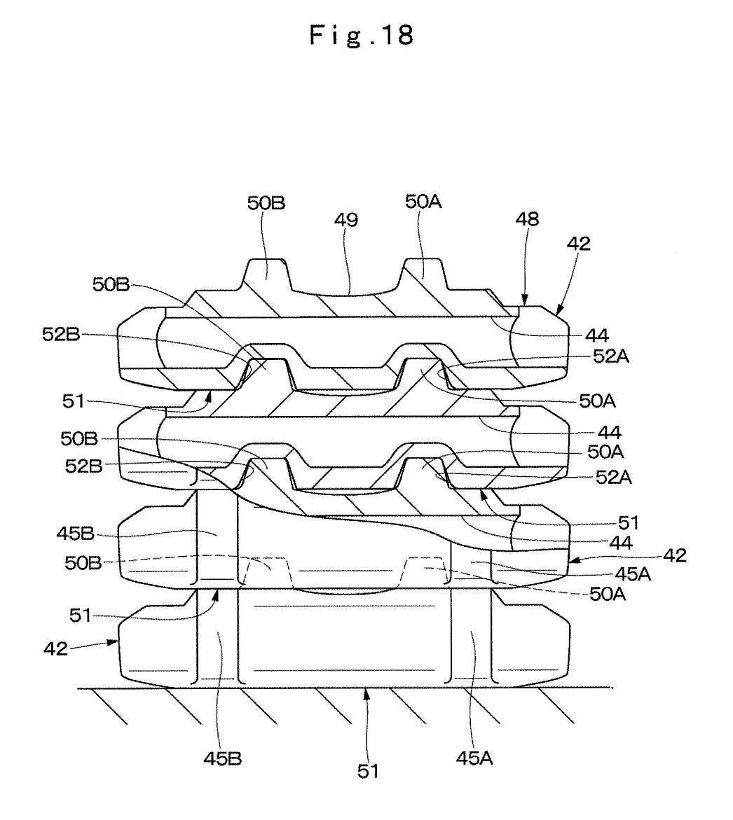

Thereby, as shown in FIG. 18, at the time of stacking up the track links 42 in the upper-lower direction, the pair of engaging projections 50A, 50B of the lower track link 42 can be respectively fitted into the pair of fitting grooves 52A, 52B of the upper track link 42.

At the time of thus stacking up the track links 42, the ground contact surface 51 of the upper track link 42 is placed on the drive wheel abutting surface 48 of the lower track link 42. At this time, since both end sides of the drive wheel abutting surface 48 in the left-right direction (closer to an outer side in the width direction than the left engaging projection 50A and the right engaging projection 50B) are formed as flat planes, the lower track link 42 can stably support the upper track link 42.

Thus, according to the third embodiment, at the time of stacking up the track links 42 in the upper-lower direction, the respective engaging projections 50A, 50B of the lower track link 42 can be fitted into the pair of fitting grooves 52A, 52B provided on the ground contact surface 51 of the upper track link 42. Therefore, with the configuration having the pair of engaging projections 50A, 50B, it is possible to stably stack up the track links 42 for storage to improve efficiency of transportation and storage of the track links 42.

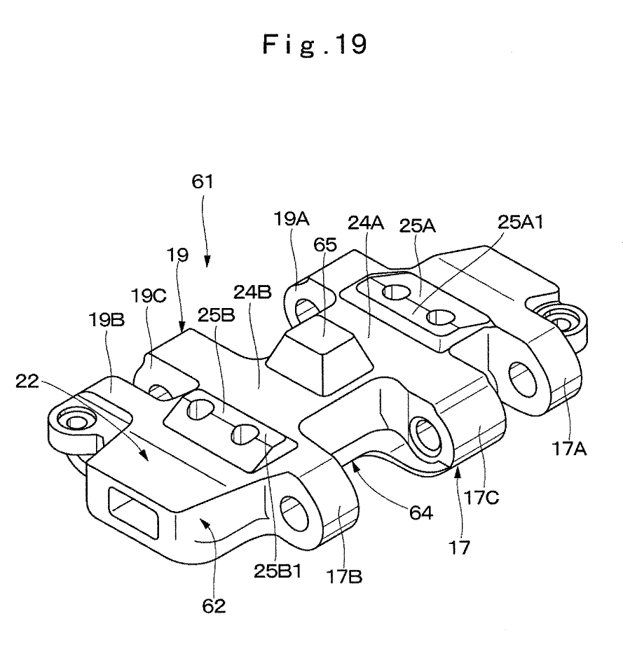

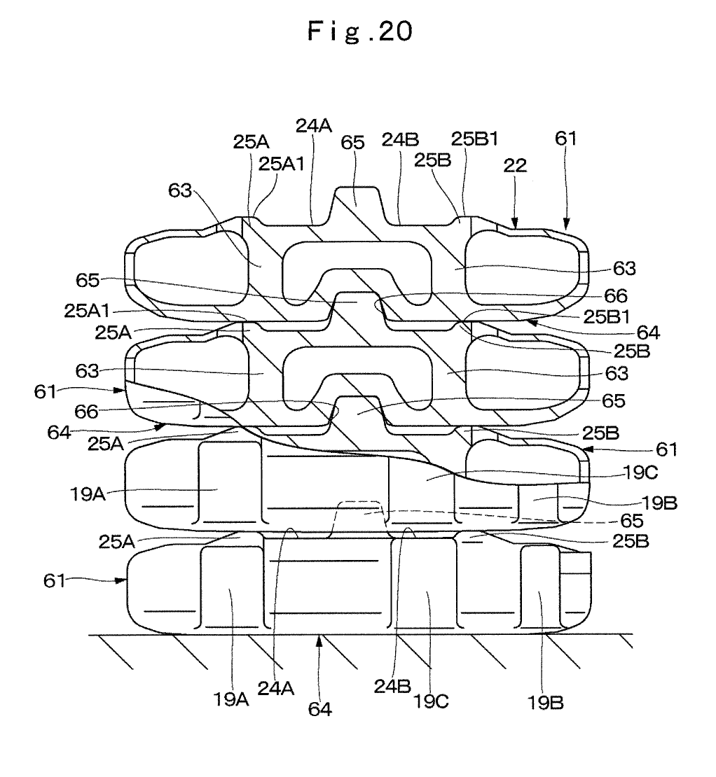

It should be noted that the first embodiment is explained by taking the track link 14 where the through hole 16 is provided inside the link base 15 to linearly penetrate therethrough in the left-right direction as an example. However, the present invention is not limited thereto. For example, as a track link 61 according to a first modification shown in FIG. 19 and FIG. 20, reinforcing ribs 63 may be provided inside a link base 62, and a fitting groove 66 into which an engaging projection 65 is fitted may be provided on a ground contact surface 64. This configuration can be applied similarly to the second embodiment and the third embodiment.

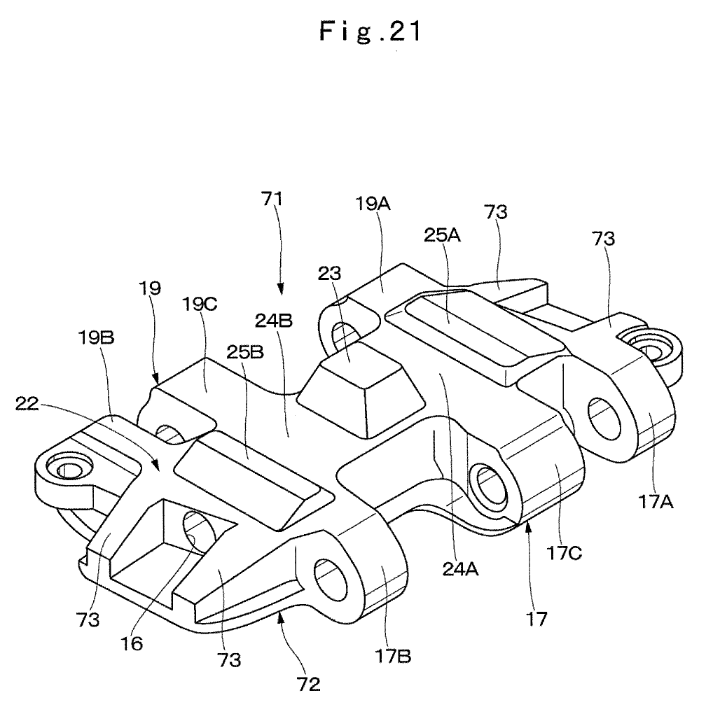

The first embodiment is explained by taking a case where the link base 15 forming the track link 14 is formed as the hollow box structure as an example. However, the present invention is not limited thereto. For example, as a track link 71 according to a second modification shown in FIG. 21, the present invention can be applied to the track link 71 having an outline shape in which ribs 73 are provided to project from a ground contact surface 72. This configuration can be applied similarly to the second embodiment, the third embodiment and the first modification.

Each of the aforementioned embodiments is explained by taking the crawler belt 13 provided in the extremely large-sized hydraulic excavator 1 as an example. However, the present invention is not limited thereto, and the present invention can be widely applied to a working vehicle in which a crawler belt is provided in a lower traveling structure, for example, a hydraulic crane or the like.

### DESCRIPTION OF REFERENCE NUMERALS

1: Hydraulic excavator (Construction machine)
11, 41: Drive wheel
12: Idler wheel
13: Crawler belt
14, 31, 42, 61, 71: Track link
15, 43, 62: Link base
17, 45: Front connecting boss
19, 47: Rear connecting boss
22, 48: Drive wheel abutting surface
23, 65: Engaging projection
24A: Left tread
24B: Right tread
25A: Left restricting projection
25B: Right restricting projection
26, 51, 64, 72: Ground contact surface
27, 66: Fitting groove
32A: Left restricting projection fitting groove
32B: Right restricting projection fitting groove
49: Tread
50A: Left engaging projection
50B: Right engaging projection
52A: Left fitting groove
52B: Right fitting groove

1. A crawler belt that is configured by sequentially connecting many track links (14, 31, 42, 61, 71) in the front-rear direction and is wound around between a drive wheel (11, 41) and an idler wheel (12) on a vehicle body (3, 5), characterized in that:
each of said track links (14, 31, 42, 61, 71) comprises:
a solid link base (15, 43, 62) having a width dimension (A) in the left-right direction larger than a length dimension (B) in the front-rear direction and a height dimension (C) in the upper-lower direction;
a front connecting boss (17, 45) and a rear connecting boss (19, 47) that are respectively provided in a front end and a rear end of said link base (15, 43, 62) and are connected respectively to said track links (14, 31, 42, 61, 71) neighbored thereto;
a drive wheel abutting surface (22, 48) that is formed in one side of said link base (15, 43, 62) in the upper-lower direction and abuts on said drive wheel (11, 41); and
a ground contact surface (26, 51, 64, 72) that is formed in the other side of said link base (15, 43, 62) in the upper-lower direction and comes in contact with the ground, wherein
an engaging projection (23, 50A, 50B, 65) that is engaged to said drive wheel (11, 41) and projects from said drive wheel abutting surface (22, 48) is provided on said drive wheel abutting surface (22, 48), and
a fitting groove (27, 52A, 52B, 66) formed of a bottomed recessed groove into which said engaging projection (23, 50A, 50B, 65) can be fitted is provided in a position corresponding to said engaging projection (23, 50A, 50B, 65) on said ground contact surface (26, 51, 64, 72), wherein
at the time of stacking up said track links (14, 31, 42, 61, 71) in the upper-lower direction, said fitting groove (27, 52A, 52B, 66) of an upper track link (14, 31, 42, 61, 71) is fitted into said engaging projection (23, 50A, 50B, 65) of a lower track link (14, 31, 42, 61, 71).

2. The crawler belt according to claim 1, wherein
an inner surface shape of said fitting groove (27, 52A, 52B, 66) is formed in a similar shape corresponding to an outer surface shape of said engaging projection (23, 50A, 50B, 65).

3. The crawler belt according to claim 1, wherein
a through hole (16, 44) is formed inside said link base (15, 43) to linearly penetrate therethrough in the left-right direction.

4. The crawler belt according to claim 1, wherein
said engaging projection (23, 65) is provided on said drive wheel abutting surface (22) of said link base (15, 62) to be positioned in the central part in the left-right direction, and
said fitting groove (27, 66) is provided on said ground contact surface (26, 64, 72) of said link base (15, 62) to be positioned in the central part in the left-right direction.

5. The crawler belt according to claim 1, wherein
said engaging projection (23) is provided on said drive wheel abutting surface (22) of said link base (15) to be positioned in the central part in the left-right direction, treads (24A, 24B) on which said drive wheel (11) and/or said idler wheel (12) abuts are provided at both sides of said engaging projection (23) in the left-right direction, and left and right restricting projections (25A, 25B) are provided closer to both sides in the left-right direction than said treads (24A, 24B) to restrict a positional shift of said drive wheel (11), and
said fitting groove (27) is provided on said ground contact surface (26) of said link base (15) to be positioned in the central part in the left-right direction and left and right restricting projection fitting grooves (32A, 32B) into which the left and right restricting projections are respectively fitted are provided at both sides of said fitting groove (27).

6. The crawler belt according to claim 1, wherein
a tread (49) on which said drive wheel (41) and/or said idler wheel abuts is provided on said drive wheel abutting surface (48) of said link base (62) in the central part in the left-right direction and a pair of said engaging projections (50A, 50B) are provided at both sides of said tread (49) in the left-right direction, and
a pair of said fitting grooves (52A, 52B) are provided on said ground contact surface (51) of said link base (62) in positions corresponding to said engaging projections (50A, 50B).
